(19) United States
(12) Patent Application Publication
(10) Pub. No.: US 2005/0057814 A1
(43) Pub. Date: Mar. 17, 2005

(54) Optical arrangement having at least one transmission component and a monitor component respectively assigned to the transmission component

(75) Inventor: Karl Schrodinger, Berlin (DE)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Infineon Technologies AG

(21) Appl. No.: 10/733,074

(22) Filed: Dec. 10, 2003

(30) Foreign Application Priority Data
Apr. 29, 2003 (DE) 10319901.2

(51) Int. Cl. G02B 27/12

(52) U.S. Cl. 359/639

(57) ABSTRACT

An optical arrangement having at least one transmission component and a monitor component that is assigned to the transmission component and detects a part of the radiation emitted by the transmission component for the purpose of monitoring the transmission component. The transmission component and the monitor component are arranged on a carrier substrate having at least one surface area that runs obliquely with regard to the surface of the carrier substrate, and deflects onto the monitor component that part of the radiation of the transmission component that is to be detected by the monitor component.

### FIELD OF THE INVENTION

The invention relates to an optical arrangement having at least one transmission component and a monitor component respectively assigned to the transmission component.

### BACKGROUND OF THE INVENTION

It is known, for the purpose of monitoring the light power of a laser diode, to use a monitor diode which detects a part of the light emitted by the laser diode and feeds it to a monitoring device.

Furthermore, parallel optical systems are known in which the optical signals of a multiplicity of optical channels are transmitted in parallel. Each channel is assigned a transmission component, generally a laser diode, and a reception component, generally a photodiode. The transmission components and the reception components are usually arranged in arrays at the transmitter end and at the receiver end.

DE 199 63 605 A1 describes an apparatus having a plurality of laser diodes arranged as an array, in which a monitor device is used in order to monitor and regulate the transmission power of the laser diodes. The monitor device comprises a transmission device formed as a laser diode, a reception device formed as a photodiode, and a control device. The light emitted by the transmission device is registered with the aid of the reception device. A signal received by means of the reception device is communicated to the control device and evaluated by the latter. The control device generates, on the basis of the evaluated signal, control signals for regulating the transmission power of the plurality of transmission diodes.

In the case of this construction, one laser diode is monitored in representative fashion for others. In order to increase the monitoring reliability however, it is desirable to be able to monitor each individual laser diode by means of an assigned monitor device.

### SUMMARY OF THE INVENTION

The present invention is is directed to an optical arrangement having at least one transmission component and a monitor component respectively assigned to the transmission component which is distinguished by a simple construction and a cost-effective production. When a plurality of transmission components are used, individual monitoring thereof is intended to be possible.

Accordingly, the optical arrangement according to the invention is distinguished by the fact that the transmission component and the monitor component are arranged on a carrier substrate having at least one surface area which runs obliquely with regard to the upper (first) surface of the carrier substrate and deflects that part of the radiation of the transmission component which is to be detected by the monitor component onto the monitor component.

The solution according to the invention provides a simple construction and a cost-effective solution. The transmission component and the monitor component may be arranged as separate elements or submodules on the carrier substrate. A reflective surface area for beam deflection is integrated into the planar carrier substrate itself, so that the optical arrangement manages with few components despite spatial separation of transmission component and monitor component.

What is more, the arrangement according to the invention permits the reception components and the monitor components to be arranged in each case as an array. The obliquely running surface area in the carrier substrate then of course has a length which at least corresponds to the length of the array, so that a part of the light of each transmission component that is to be detected is in each case directed onto the associated reception component by the obliquely running surface area.

The arrangement according to the invention is suitable for mass production on the basis of wafer processes, transmission components and monitor components being produced on a wafer and then being singulated—if appropriate as an array. In this case, the transmission components and monitor components can be tested 100 percent before a singulation.

In one preferred refinement, it is provided that the transmission component emits that part of the radiation which is to be detected by the monitor component downward, in the direction of the carrier substrate, this part of the radiation being reflected at the obliquely running surface area. In this case, the transmission component is preferably a vertically emitting planar element whose optically active zone is formed on the top side of the element. A part of the radiation generated is coupled out from the underside of the carrier chip in the direction of the carrier substrate. In this case, the substrate of the transmission component is transparent to the radiation generated. The optically active zone of the transmission component projects above the obliquely running surface area of the carrier substrate, so that the light emerging at the underside falls directly onto the obliquely running surface area of the carrier substrate.

In a further preferred refinement, the monitor component has an obliquely ground surface area in such a way that the radiation reflected from the obliquely running surface area of the carrier substrate is refracted at the obliquely ground surface area of the monitor component in the direction of the optically active zone of the monitor component. In this case, the optically active zone of the monitor component is preferably formed on the latter's top side remote from the carrier substrate.

In the case of this arrangement, the carrier substrate preferably has two planes of different height, which are connected to one another by the obliquely running surface area, the transmission component being arranged on one plane, situated at a higher level, and the monitor component being arranged on the other plane, situated at a lower level, so that the light reflected at the obliquely running surface area of the carrier substrate falls laterally onto the reception component.

The obliquely running surface area of the carrier substrate runs at an angle of 45°, for example, other angles likewise being possible. The obliquely running surface area is preferably produced by etching processes, so that the slant of the surface area is prescribed by the crystal structure of the etched carrier substrate. In principle, the slant in the carrier substrate can also be produced by techniques other than etching, such as grinding and milling.

In an advantageous refinement, the carrier substrate has a second obliquely running surface area which deflects radiation reflected from the first obliquely running surface area onto the monitor component. In this case, the radiation deflected by the second obliquely running surface area radiates preferably through the monitor component from the underside and is preferably detected by an optically active zone formed on the top side of the monitor component.

By way of example, the two obliquely running surface areas of the carrier substrate may represent lateral edges of a cutout of the carrier substrate, which cutout has been etched or milled, for example, into said carrier substrate.

The transmission component and the reception component are preferably formed as submodules that are produced and are to be contact-connected separately. Subcomponents which are formed in planar fashion and can be integrated into planar optical circuits or other planar components are preferably involved.

As already mentioned, the arrangement preferably forms a parallel optical system having a multiplicity of transmission components and a multiplicity of monitor components respectively assigned to the transmission components. In this case, the submodules preferably respectively form an array of transmission components and an array of monitor components.

The transmission components are preferably lasers, in particular vertically emitting lasers (VCSEL). In principle, however, it is also possible to use other light-generating components such as light-emitting diodes. The monitor components are preferably photo-diodes.

### BRIEF DESCRIPTION OF THE DRAWINGS

The invention is explained in more detail below using two exemplary embodiments with reference to the figures of the drawings, in which:

FIG. 1 shows a first exemplary embodiment of an optical arrangement having a transmission component and a reception component which are arranged on a planar carrier; and

FIG. 2 shows a second exemplary embodiment of an optical arrangement having a transmission component and a reception component which are arranged on a planar carrier.

### DESCRIPTION OF A PREFERRED EXEMPLARY EMBODIMENT

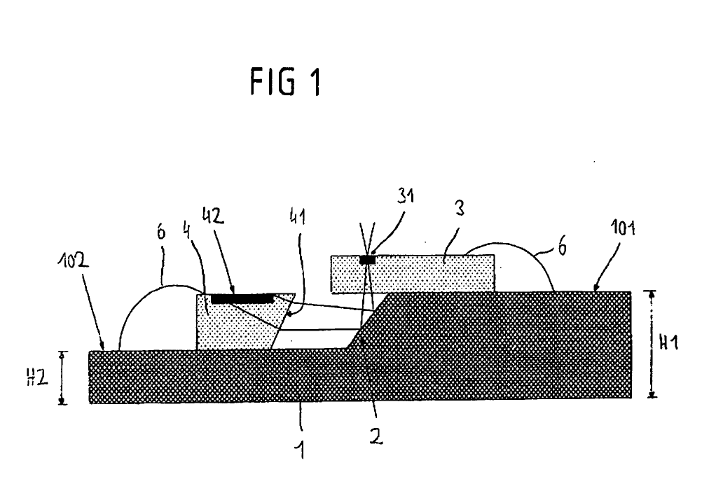

FIG. 1 shows an optical arrangement having a planar carrier substrate 1, which forms two plane regions 101, 102 having a first height H1 and a second height H2. The regions 101, 102 of different height H1, H2 are connected to one another by an obliquely running surface area 2. The carrier substrate comprises silicon, for example, but may also comprise other materials.

A vertically emitting laser diode 3 is arranged on the region 101 situated at a higher level of the carrier substrate 1, the optically active zone 31 of which laser diode points upward, i.e. away from the upper surface of the carrier substrate 1. The laser diode 3 has an optical resonator in the region of the optically active zone 31, which optical resonator emits laser light primarily upward. However, the (lower) side opposite to the primary light exit side of the resonator likewise emits light, the light power of this laser light amounting only to a fraction of the light power of the light that is emitted upward. This light coupled out on the rear side is detected by a monitor diode 4 for monitoring purposes, the monitor diode 4 being connected to a control device (not illustrated) for controlling the laser diode 3.

The substrate of the laser diode 3 is transparent to the emitted light, so that the light emitted downward passes through the substrate and is emitted at the underside of the laser diode 3, as indicated in the beam path depicted.

Since the optically active zone 31 of the laser diode 3 is situated above the obliquely running surface area 2 of the carrier substrate, the light emitted downward falls onto the obliquely running surface area 2 and is reflected at the latter. For this purpose, the obliquely running surface area 2 may additionally be provided with a mirror coating. In the exemplary embodiment illustrated, the obliquely running surface area 2 is oriented at an angle of 45°, so that the light emitted by the laser diode 3 is deflected laterally. However, it is also possible to choose other angles which provide an essentially lateral deflection of the light.

The monitor diode 4 is situated at the lower plane 102 of the carrier substrate 1, which monitor diode forms an optically active zone (pn junction) at the top side. The light reflected at the obliquely running surface area 2 is detected by the monitor diode 4. For this purpose, in the exemplary embodiment illustrated, the monitor diode 4 is ground obliquely at the side 41 facing the obliquely running surface area 2 of the carrier substrate 1, to be precise in such a way that the light reflected at the obliquely running surface area 2 is directed onto the optically active zone 42 of the monitor diode. In this case, it is not necessary for one hundred percent of the reflected light to be captured at the monitor diode 4. It suffices to image a representative part onto the monitor diode 4 or the active zone 42 thereof.

As an alternative, provision may be made for providing between the obliquely running surface area 2 of the carrier substrate 1 and the monitor diode an optical arrangement, for instance in the form of a lens or lens combination, which precisely images the light onto the optically active zone 42 of the monitor diode. Such a configuration is expedient if the entire light is to be detected at the monitor diode 4.

The laser diode 3 and the monitor diode 4 are constructed as planar optical components which can be produced in mass production on the basis of wafer processes and can be tested hundred percent before singulation. Electrical contact connection is effected in a customary manner by means of bonding wires 6 and metallizations (not illustrated) on the carrier substrate 1.

The optical arrangement described preferably has arrays of laser diodes 3 and arrays of monitor diodes 4 which extend in a direction perpendicular to the plane of the drawing of FIG. 1. The arrays are embodied in separately produced submodules arranged on the carrier substrate 1. In this case, each laser diode 3 is assigned a monitor diode 4, so that the laser diodes 3 can be monitored with high accuracy and reliability. The obliquely running surface area 2 has a length perpendicular to the plane of the drawing which corresponds to the extent of the arrays, so that it can serve in each case for light coupling purposes.

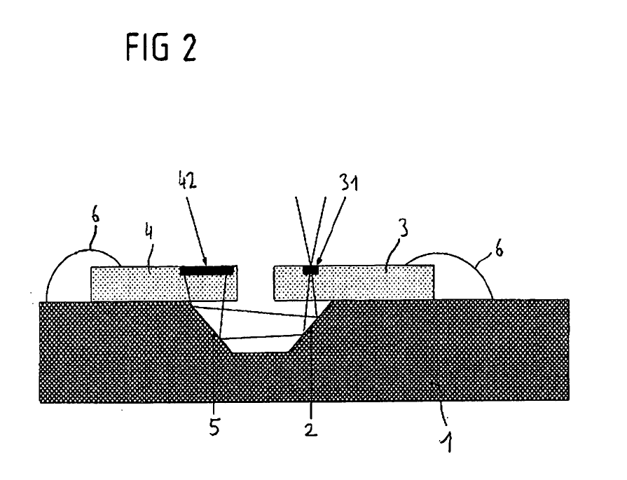

In the configuration of FIG. 2, the planar carrier substrate 1 has only one plane. Besides the first obliquely running surface area 2, a second obliquely running surface area 5 is provided, at which the light reflected at the first obliquely running surface area 2 is reflected again. The oblique surface areas 2, 5 form the side edges of a cutout introduced into the carrier substrate 1, said cutout having been produced by preferred etching or milling, for example.

The inclination of the two oblique surface areas 2, 5 preferably corresponds to one another, but need not necessarily correspond to one another. The two oblique surface areas 2, 5 may be provided with a mirror coating.

The monitor diode 4 arranged above the second obliquely running surface area 5 is irradiated by the reflected light from the rear side. The optically active zone 42 is situated at the top side of the monitor diode 4 and above the second obliquely running surface area 5 of the carrier substrate, so that the reflected light falls directly onto it. In the same way as in the exemplary embodiment of FIG. 1, the substrate of the monitor diode 4 is transparent to the wavelengths used. For the rest, the construction corresponds to the construction of FIG. 1.

The configuration of the invention is not restricted to the exemplary embodiments represented above. By way of example, instead of vertically emitting laser diodes, it is possible to use laterally emitting laser diodes with a deflection optical arrangement. Furthermore, the optically active zone may, in principle, also be formed at the lower side facing the carrier substrate. The geometry of laser diode and monitor diode, in the same way as the contact connection of the elements, is to be understood as only by way of example. The formation of the carrier substrate is also to be understood as only by way of example. Besides the planes and/or regions illustrated there may be further planes and/or regions present. All that is essential is that an area which runs obliquely with regard to the upper surface of the carrier substrate is integrated into the carrier substrate and enables light coupling between transmission component and monitor component.

1. An optical arrangement comprising at least one transmission component for emitting radiation and a monitor component which is respectively assigned to the transmission component and detects a part of the radiation emitted by the transmission component for the purpose of monitoring the transmission component, wherein
the transmission component and the monitor component are arranged on a carrier substrate having an upper surface and at least one surface area which extends obliquely with regard to the upper surface, and wherein the obliquely extending surface area deflects onto the monitor component the part of the radiation emitted by the transmission component which is to be detected by the monitor component.

2. The arrangement as claimed in claim 1, wherein the transmission component emits the part of the radiation which is to be detected by the monitor component downward, in the direction of the carrier substrate, this part of the radiation being reflected at the obliquely extending surface area.

3. The arrangement as claimed in claim 2, wherein the transmission component comprises a vertically emitting element whose optically active zone is formed on a top side of the element, and the part of the radiation that is detected by the monitor component being transmitted out from an underside of the element in the direction of the carrier substrate.

4. The arrangement as claimed in claim 3, wherein the monitor component has an obliquely ground surface area oriented in such a way that the radiation reflected from the obliquely extending area of the carrier substrate is refracted at the obliquely ground surface area of the monitor component in the direction of the optically active zone of the monitor component.

5. The arrangement as claimed in claim 4, wherein the optically active zone of the monitor component is formed on a top side that faces away from the carrier substrate.

6. The arrangement as claimed in claim 1, wherein the obliquely extending surface area of the carrier substrate extends at an angle of 45° relative to the upper surface.

7. The arrangement as claimed in claim 1, wherein the upper surface defines a first plane, and the carrier substrate includes a second surface defining a second plane that is parallel to the first plane, the first and second planes having different heights and being connected by the obliquely extending surface area, the transmission component being arranged on the upper surface and the monitor component being arranged on the second surface.

8. The arrangement as claimed in claim 1, wherein the carrier substrate comprises a second obliquely extending surface area which is oriented to deflect the part of the radiation reflected from the first obliquely extending surface area onto the monitor component.

9. The arrangement as claimed in claim 8, wherein the part of the radiation deflected by the second obliquely extending surface area radiates through an underside of the monitor component and in the process is detected by an optically active zone formed on a top side of the monitor component.

10. The arrangement as claimed in claim 9, wherein the two obliquely extending surface areas of the carrier substrate represent lateral edges of a cutout formed in the upper surface of the carrier substrate.

11. The arrangement as claimed in claim 1, wherein the transmission component and the reception component comprises submodules that are contact-connected to the carrier substrate.

12. The arrangement as claimed in claim 1, further comprising a plurality of second transmission components mounted on the upper surface, and a plurality of second monitor components respectively assigned to corresponding ones of the plurality of transmission components.

13. The arrangement as claimed in claim and 12, wherein the plurality of second transmission components and the plurality of second reception components comprise submodules that are contact-connected to the carrier substrate, and wherein the submodules are respectively formed as an array of transmission components and an array of monitor components.

14. The arrangement as claimed in claim 1, wherein the transmission component comprises a laser.

15. The arrangement as claimed in claim 1, wherein the monitor component comprises a photodiode.

16. An apparatus comprising:
a substrate including a first surface defining a first plane and a second surface defining a second plane that extends obliquely relative to the first plane;
a transmission component mounted on the first surface for emitting radiation such that a portion of the emitted radiation is reflected by the second surface; and
a monitor component mounted on the substrate and positioned to receive the reflected portion of the emitted radiation.

17. The apparatus of claim 16,
wherein the substrate further includes a third surface defining a third plane that is parallel to the first plane,
wherein the second surface extends between the first surface and the second surface, and
wherein the monitor component is mounted on the third surface.

18. The apparatus of claim 17,
wherein the monitor component includes a side surface defining an oblique angle relative to the third surface, and
wherein the monitor component is positioned such that the reflected portion of the emitted radiation passes through the side surface.

19. The apparatus of claim 16,
wherein the substrate further includes a third surface located in an optical path between the second surface and the monitor component, and
wherein the third surface is oriented to reflect the portion of emitted radiation, after being reflected by the second surface, to the monitor component.

20. The apparatus of claim 19,
wherein the transmission component is mounted on a first section of the first surface,
wherein the monitor component is mounted on a second section of the first surface, and
wherein the second and third surfaces define a cutout located between the first and second sections of the first surface.
